(19) United States
(12) Patent Application Publication
(10) Pub. No.: US 2014/0104268 A1
(43) Pub. Date: Apr. 17, 2014

(54) METHOD AND APPARATUS FOR CORRECTING STEREOSCOPIC DISPLAY EDGE VIOLATIONS

(71) Applicant: Lenny Lipton, Los Angeles, CA (US)

(72) Inventor: Lenny Lipton, Los Angeles, CA (US)

(21) Appl. No.: 13/652,394

(22) Filed: Oct. 15, 2012

(51) Int. Cl. G06T 19/20

(52) U.S. Cl. 345/419

(57) ABSTRACT

A method and apparatus for creating a stereoscopic image. The design includes creating a depth map of an original image, such as a moving image, by assigning bright pixels to near regions and dark pixels to far regions such that distance is proportional to pixel brightness, altering an edge region of the depth map of the original image gradually toward zero parallax at an edge of the original image, forming an altered depth map, and combining the altered depth map with the original image to form the stereoscopic image.

### BACKGROUND OF THE INVENTION

1. Field of the Invention

The present application relates generally to the art of the display of stereoscopic images, and more particularly to eliminating “edge violations” that occur during the display of stereoscopic images.

2. Description of the Related Art

Stereoscopic images projected on theater-size screens or displayed on relatively small screens, such as television screens, are not isomorphic with the visual world. Some of these departures from the one-to-one correspondence between the 3-D display and the visual world can cause viewer discomfort. A case in point arises from the fact that images with negative values of parallax, also known as off-screen parallax, will often produce confusion and “eyestrain” or discomfort for the observer if they are occluded by the edges of the screen itself. The reason for this difficulty is well known in the art and is called an “edge violation”. Elimination of this perceptual anomaly is highly desirable.

A discussion of screen parallax, a concept well understood by workers in the art, is given in Lipton's Foundations of the Stereoscopic Cinema, Van Nostrand Reinhold Co. Inc, New York, 1982, and is included by reference herein.

Edge violations arise at the vertical edges of the screen surround because of a conflict of perceptual depth cues. Negative parallax is the stereoscopic depth cue that tells the viewer that the image must be closer to him or her than the screen, while the occlusion cue, the fact that the image is cut off by the edge of the screen, tells the viewer that the image must be behind the screen plane. Such a conflict of depth cues gives rise to visual confusion for some observers and distress or visual fatigue for others.

Another perplexing aspect of this visual conundrum is the fact that when looking through the left edge of a window, for example, the right eye sees more of what is behind the window than the left eye, but when observing a stereoscopic image with negative parallax that is occluded by the left vertical screen surround, the right eye sees less of the image and the left eye sees more of the image. A similar description applies to the right edge of a window or the right edge of a screen. This anomaly does not occur for the top and bottom horizontal screen surround edges, thus making these conflicts relatively benign compared to that which occurs at the vertical edges. A solution addressing the conflicts at the vertical screen surround edges in this environment would be beneficial.

The principal means to cure this problem has been the use of so-called “floating windows” adjusted to hover into audience space. A floating window is achieved by “printing” vertical black bars on the left and right edges of the image to create negative parallax values for the left and right edges of the stereoscopic image. In this way, a negative parallax effigy of a screen surround is placed in front of portions of images that would have had conflicting cues. A theater screen surround has a value of zero parallax, thus the “virtual window”, as it is sometimes called, allows for images with great values of negative parallax to be comfortably viewed.

Another, and perhaps more obvious cure, is to simply not compose images so that they extend beyond the plane of the screen at the vertical edges to adjust compositions so that images with negative parallax values do not appear at the screen vertical edges. The application of this technique to stereoscopic cinematography curtails the parallax budget or depth range of the image. In other words, such images will have less parallax and less of a depth effect. This defeats the purpose of stereoscopic imaging, namely to create images with a strong depth effect.

One trick used by cinematographers is employed, for example, in over-the-shoulder shots when the actor is at the very horizontal edge of the composition and thus partly occluded by the vertical edge of the surround. In this case the actor can be in the shadows, or dressed in dark clothes, to produce a semi-silhouette, which blends into the screen surround to make it unobtrusive. Tricks like this do not provide a general solution to the conflict of the cue/edge violation dilemma.

Another reason for providing an alternative to the virtual window has to do with projection practices. Frequently the projected image is adjusted so that it bleeds over the screen surround onto the black masking. This is a commonplace practice which is unnecessary for digital projection but has been the practice, for more than a century, using 35 mm film projectors. This results in the clipping off the virtual window eliminating its benefits.

It would therefore be beneficial to provide a solution that addresses the problem of edge violations to overcome drawbacks present in previous approaches.

### DESCRIPTION OF THE DRAWINGS

FIG. 1 is an image of a chessboard captured from a low angle;

FIG. 2 is a depth map of the image in FIG. 1;

FIG. 3 is a depth map of the image in FIG. 1 which has been treated to address edge issues;

FIG. 4 is a generalized hardware implementation of one embodiment of the present design; and

FIG. 5 illustrates fundamental components of the present design.

### DETAILED DESCRIPTION OF THE INVENTION

The present design reduces or eliminates edge violations for stereoscopic images that use depth maps for depth information encoding in image capture, postproduction, transmission, or reception, and display. The design presented here may be employed at any point in the entire stereoscopic transmission system, from source to display.

The present design addresses stereoscopic displays and seeks to reduce or eliminate viewer eyestrain and visual fatigue arising when images having negative parallax are occluded by the vertical screen surround edges. The present design employs depth maps in a manner that addresses the edge violation problem.

The present design does not employ a virtual window and thus does not clip off a virtual window due to sloppy projection practices. In fact, the image at the surround, at both left and right edges of the field, for both left and right components of the stereo pair, have a symmetry in terms of image density and thus avoid the virtual window clipping issue.

Depth maps are used for the production of titling in television postproduction, in the preparation of films to be released in digital formats such as Blu-ray, and for autostereoscopic displays that require the generation of many perspective views. For titling, depth maps are used in an automatic or semi-automatic process to set the proper Z depth of lettering so that the parallax values of such on-screen titles do not produce a conflict of cues with the underlying image. For autostereoscopic displays depth maps are used as source material for the generation of multiple views when used in combination with planar images or stereo pairs.

It has been found that the use of depth maps provides the opportunity for controlling edge violation issues, and thus the technology described in this disclosure becomes of great importance in controlling the appearance and enjoyment of stereoscopic images.

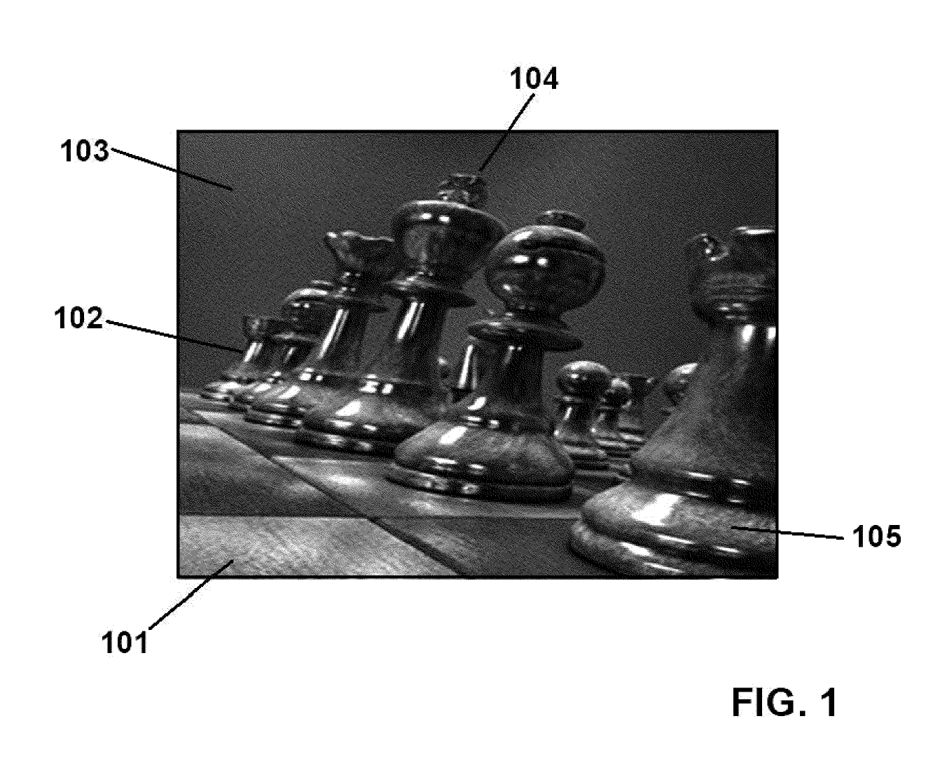

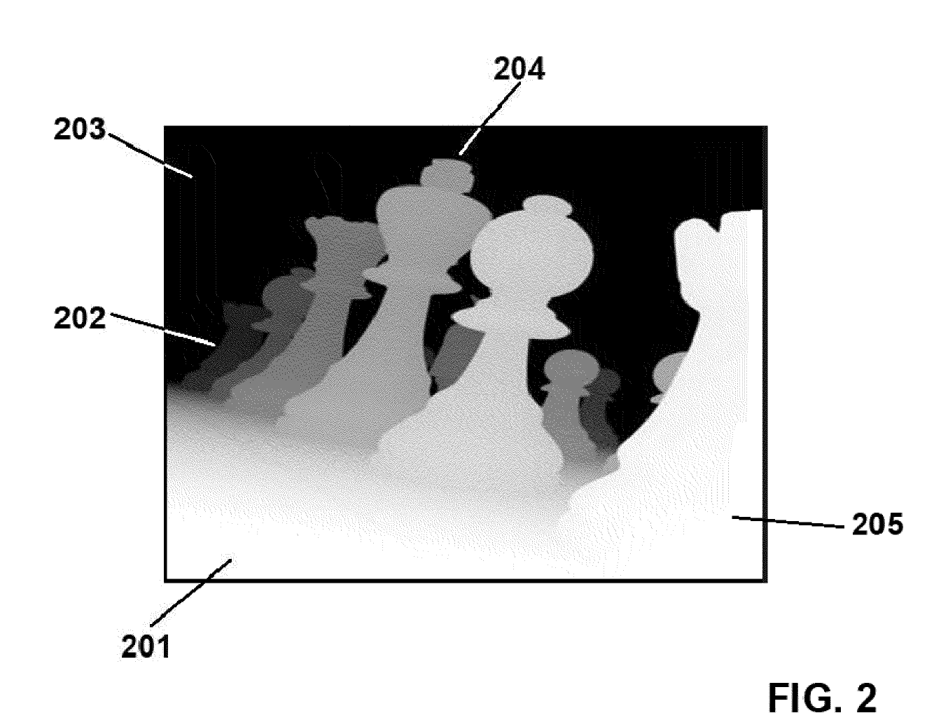

FIG. 1 is a planar image whose depth content is contained in the depth map shown in FIG. 2. FIG. 1 illustrates a foreground portion 101 of a chess board, rearmost chess playing piece 102, background 103, chess piece 104 located at or near zero parallax, or at the plane of the screen, and foreground chess piece 105.

Depth maps use image density to encode parallax information. For the case of the depth map shown here, bright pixels are near and dark pixels are far with distance being proportional to pixel brightness. The depth content corresponding to those portions of the planar image are depicted in depth map FIG. 2. The depth map (sometimes called a parallax map or a disparity map) provides the parallax values of the planar image pixel by pixel, as co-located on a Cartesian grid. The planar image's depth is provided on a pixel by pixel basis by the depth map's corresponding pixel brightness. The parallax information for depth is thus provided. To reiterate, the brightness values of the depth map are a means for coding parallax values.

Thus region 201, which is the brightest region of the chess board, is closest to the observer with the largest value of negative parallax (where the convention is that negative parallax is off-screen, zero parallax is at the plane of the screen, and positive parallax is within screen space). Similarly chess piece 206 is the chess piece whose depth map is brightest and thus has the greatest value of negative parallax. Background 203 is darkest and thus the area with the greatest positive parallax and deepest into the screen while chess piece 204 is at the plane of the screen with an approximately 50% gray value. Chess piece 202 is the rearmost chess piece and has the darkest value of any of the chess pieces.

By means that are beyond the scope of this disclosure, which are well known in the art, the combination of planar image, as shown in FIG. 1, and the depth map image, as shown in FIG. 2 can be used to create stereo pairs, or the multiplicity of perspective views that are required for an autostereoscopic display. While various methods and techniques could be employed, one example for accomplishing this is given in U.S. Patent Publication 2010/0215251, inventors Klein Gunneweiek et al., the entirety of which is incorporated herein by reference.

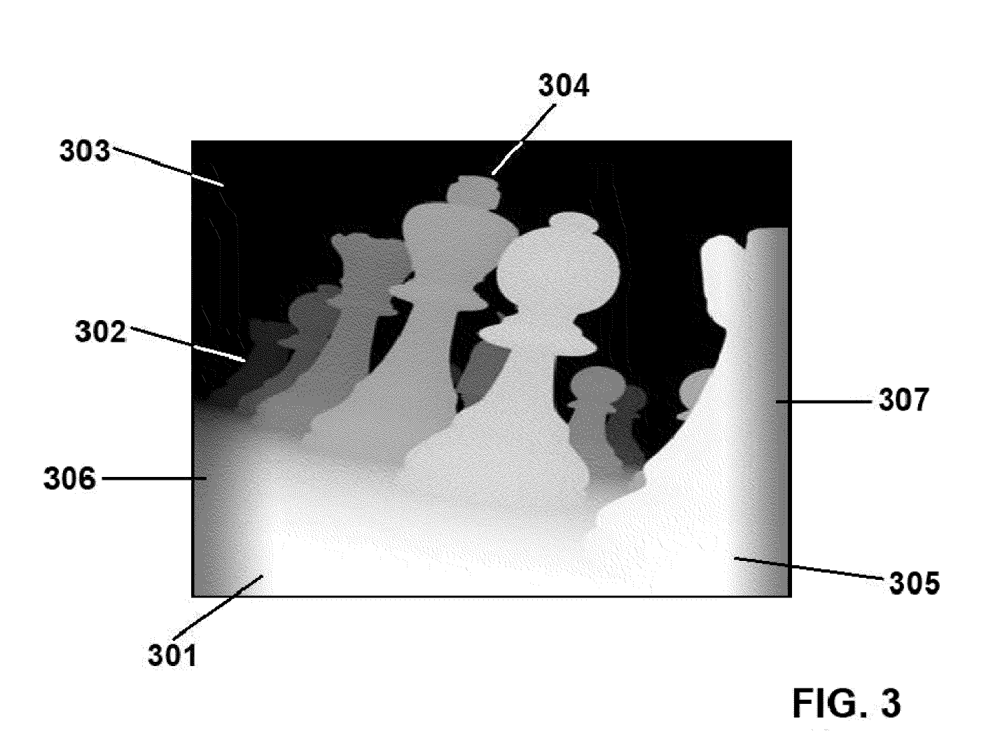

FIG. 3 illustrates a depth map that has been treated using that art. Region 301 indicates the extreme foreground of the chessboard, chess piece 302 is the distant-most chess piece, 303 represents the density for the distance of the background, chess piece 304 is the zero parallax or mid-distance distant chess piece with a mid-value density, and region 305 is the density of the closest and brightest chess piece.

Regions 306 and 307 depict regions of shading that have been added to the left and right edge areas of the depth map. The shadings have the effect of rolling-off parallax values so that at the vertical edge of the image the parallax values gradually become zero, for a neutral grey and so are adjusted to be at the plane of the screen. For the left shading at 306, the very leftmost edge of the image has been adjusted to have same value as that of chess piece 304, which is at zero parallax, and the very rightmost portion of shading region 306 is totally transparent so that the maximum negative parallax value of the foreground chess board 301 remains unaffected.

Shaded region 307 behaves in the same fashion rolling off parallax values at the right edge of the display screen. Thus the parallax values are reduced gradually towards the left and right edges of the surround since the shading or changes in density which are been added to the vertical edges of the image are interpreted as the gradual reduction of parallax. Parallax is thus reduced to zero at the edges. The rate at which this diminution of density or application of shading occurs can be controlled by either changing both the width or the rate of the diminution in density. The rate of diminution does not have to be linear, and the horizontal extent of shading can be accomplished as a matter of aesthetic choice by an operator or by automatic algorithmic means. Different values of shading may be added to the depth map at the right and left edges or omitted from one of the edges.

Density may be added equally to all values of the image, and density may also be added to only the brightest pixel values, or highlights. In the first approach, density can be added both to the brightest portions of the image with the greatest negative values of parallax, and to the darkest portions of the image with the greatest values of positive parallax.

The densest portions of the map are little affected. This particular process pinches or squeezes both negative and positive values of parallax to zero at the extreme vertical edges, but has a greater effect on light regions of the depth map. Moreover, since the positive values of parallax are associated with objects in the distance that are occluded by the negative value parallax objects, changes to background values are generally unobtrusive.

However it is possible to employ other shading algorithms well known in the art so as to “crush” or only reduce the density of the brightest values in the depth map and hence the greatest values of negative parallax. In this way only the negative values, the off-screen parallax values, will be reduced to zero at the extreme screen surround edges.

The technique described here can be applied at the time of photography, i.e. at content creation, during postproduction, during transmission of the digital image, or within a receiver itself, such as a television set, a handheld device, a laptop, tablet, or PC display screen. The technique is not limited to a simple linear falloff shading of all densities, but other density change algorithms known in the art may be applied with equal efficacy depending upon the effects that are desired.

The general technique results in a gradual reduction of negative parallax values towards the left and right edges of the display screen so that these negative parallax values become zero parallax values. Since the screen surround is at zero parallax, no conflict of cues occurs, and the edge violation anomaly is obviated. Further, an operator can control the extent of shading, i.e. how far into the image in a horizontal direction the shading extends, and can also control the slope or shape of the density change since the density rate of change does not have to be linear.

The technique can be applied independently to the left and right screen surround edges. For example, no shading can be applied to one edge and shading can be applied to the other, or the amounts of shading and their extent can be applied differently to the left and right edges of the image depending upon the composition in the effect desired.

The shading can be controlled by an operator or automatically. The term shading used here can be applied to any of a host of algorithms that can be used to reduce the density of the image in different fashions.

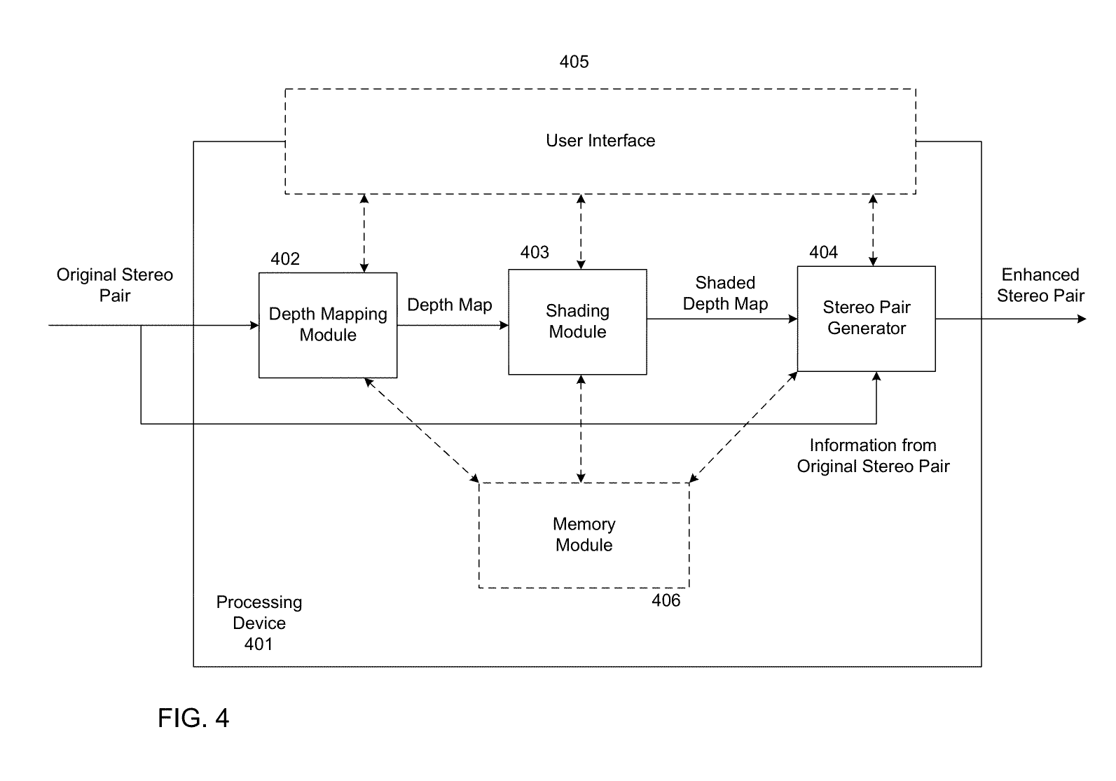

An example of a hardware implementation in a post-production scenario is presented in FIG. 4. From FIG. 4, processing device 401 obtains a stereo pair, i.e. the stereoscopic image to be processed. While shown as a single line in FIG. 4, it is to be understood that a single channel or two channels may be employed to provide the stereo pair. Depth mapping module 402 creates a depth map of the stereo pair, where again, depth mapping consists of assigning bright pixels to near regions and dark pixels to far regions, with distance being proportional to pixel brightness. Shading device 402 then applies the shading to the edges of the depth map as discussed, producing a shaded depth map, i.e. an edge treated depth map. Stereo pair generator 404 then takes the shaded depth map and information from the original stereo pair, including all the information provided in the stereo pair, and produces an enhanced stereo pair.

Producing a stereo pair using a depth map is generally known in the industry and is used largely in the field of subtitles, i.e. producing subtitles for use with stereoscopic images and films. Stereo pair generator essentially acts as a combiner, combining the original stereo pair or portions thereof with the depth map to create the enhanced stereo pair.

The processing device 401 may interact with user interface 405 wherein a user may be provided with an option to alter relevant parameters, provide shading instructions, and so forth. The user interface 405 may be employed with any or all of depth mapping module 402, shading module 403, and/or stereo pair generator 404.

The user interface 405 may enable a user to select a region or regions of the image, including individual frames of a moving image and/or multiple frames of a moving image, and employ the gradual or graduated edge processing described herein based on user indications. For example, the user may wish to address edge issues on the left side of a group of images, and may select the desired left edge region for processing. Shading module 403 may be employed to alter the depth map to fade or alter the image toward the left side of the image in the region selected by the user. While not shown in FIG. 4, memory device 402 may hold the original image for later transmission. Memory device 402 may be used to maintain any data, information, images, settings, or other information needed to accomplish the functionality described herein, i.e. may hold the original depth map, altered depth map, original image(s), etc. Processing “on the fly” may be performed wherein the depth map and stereo pairs are not stored in memory device 402.

Memory device 405 is illustrated as being within processing device 401 but may be separate therefrom.

Again, while illustrated in FIG. 4 as part of a post-production device, the present design may be implemented in any processing device able to take an image, such as a moving image, and produce an altered depth map of the image and an enhanced stereo pair as described herein. The processing device may maintain the original stereo pair, the depth map, and/or the altered depth map, and at a later time, the same processing device or a different processing device may combine the altered depth map and original image into the stereo pairs. Such an arrangement design may be employed by a camera, an on-set processor, a post-production device as shown, or any other applicable device and/or any combination thereof. As noted, while illustrated as being part of processing device 401, the various modules may be separate from other modules while still within the scope of the present invention.

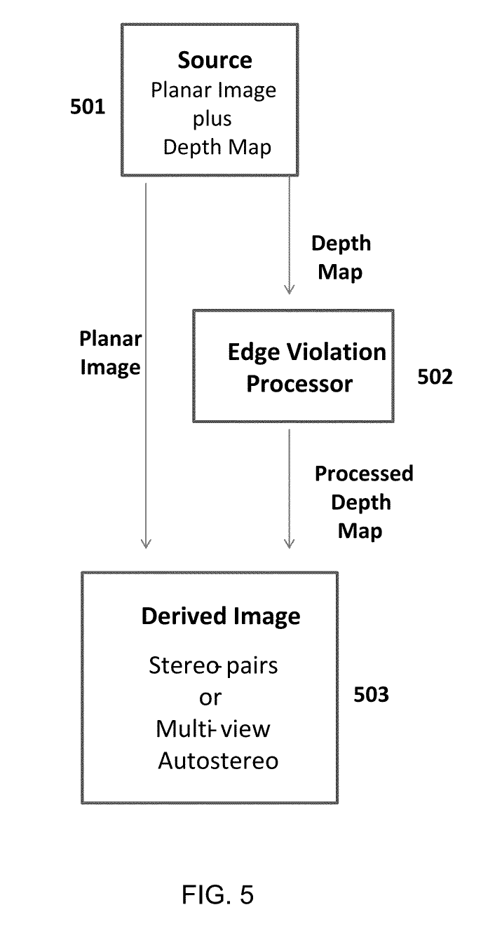

FIG. 5 illustrates the overall process of the present design. FIG. 5 is general in that it can be used to explain the flow of image processing in various applications such as in postproduction where the process can be automatic, semiautomatic, or manual, or in a television receiver in which the edge violation processor is algorithmic and automatic. Source 501 consists of both a planar image and a depth map. The planar image and the depth map need to be in synchronization when joined at the derived image assembler 503. The planar image is unmodified and flows to derived image assembler 503. The unmodified image may be delayed in passing from source 501 to derived image assembler 503 because it may take time to process the depth map edge violation at edge violation processor 502. The purpose of this delay is to produce field-for-field synchronization between the planar image and the depth map.

The depth map image flows from source 501 to edge violation processor 502. The edge violation processor 502 applies the shading or brightness reduction described. Then the processed edge violation corrected depth map flows to derived image assembler 503 and is combined with the corresponding planar image. The two are thus in synchrony and may be transmitted to a display (not shown) by various means. For example, the two images may be recorded and used as a master for distribution by any one of various means. Alternately, the processed depth map and the planar image may be transmitted to a television receiver and processed in the receiver to produce a stereoscopic or auto stereoscopic image.

What has been described here is a general technique for reducing parallax values at the edges of the screen surround, or towards the edges of the screen surround, using depth maps as the vehicle for such changes, by using shading algorithms to control density to gradually reduce parallax values to zero. The benefit of this technique is to eliminate so-called edge violations which are produced by a conflict of perceptual cues, the cue of interposition and stereopsis, and can thus create a feeling of confusion and discomfort in the observer of stereoscopic images.

While primarily described herein with respect to an exemplary stereoscopic image creation apparatus and method, the invention and disclosure herein are not intended to be so limited. Note that while certain examples are provided herein, these examples are meant to be illustrative and not limiting as to the functionality of the present system and method. Other examples and implementations are possible and this document should not be limited by the examples presented. Other examples of maintaining a preferred position for a wireless communication device may be realized using the current design.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

1. A system for creating a stereoscopic image, comprising:
means for receiving an original image and creating a depth map of the original image, the depth map comprising a left side depth map side region adjacent to a left edge of a periphery of the depth map and a right side depth map side region adjacent to a right edge of the periphery of the depth map, wherein the depth map assigns brightest pixels to original image features having largest values of negative parallax transitioning to darkest pixels to original image features having largest values of positive parallax;
means for altering the left side depth map side region and the right side depth map side region of the depth map gradually toward zero parallax at the left edge and the right edge, respectively, of the depth map while maintaining parallax and brightness values of the depth map outside the left side depth map side region and the right side depth map side region, thereby forming a side region altered depth map; and
means for combining the side region altered depth map with the original image to produce the stereoscopic image.

2. The system of claim 1, wherein the means for receiving, means for altering, and means for combining comprise a processor.

3. The system of claim 1, wherein the means for receiving, means for altering, and means for combining comprise a plurality of processors.

4. The system of claim 1, further comprising a storage element configured to maintain data.

5. The system of claim 4, wherein the means for receiving receives the original image from the storage element.

6. The system of claim 4, wherein the means for combining provides the stereoscopic image to the storage element.

7. The system of claim 1, wherein the means for altering comprise means for receiving edge alteration information from a user via a user interface and employing the edge alteration information in forming the side region altered depth map.

8. A method for creating a stereoscopic image, comprising:
receiving an original image at a processing device;
creating a depth map of the original image using the processing device, the depth map comprising a left side depth map side region adjacent to a left edge of a periphery of the depth map and a right side depth map side region adjacent to a right edge of the periphery of the depth map, said creating comprising assigning brightest pixels to original image features having largest values of negative parallax transitioning to and darkest pixels to image features having largest values of positive parallax.
altering the left side depth map side region and the right side depth map side region of the depth map gradually toward zero parallax at the left edge and the right edge, respectively, of the depth map while maintaining parallax and brightness values of the depth map outside the left side depth map side region and the right side depth map side region, thereby forming a side region altered depth map; and
processing the side region altered depth map to form the stereoscopic image.

9. The method of claim 8, wherein processing the side region altered depth map comprises combining the side region altered depth map with the original image to produce the stereoscopic image.

10. The method of claim 8, further comprising maintaining data a storage device.

11. The method of claim 10, wherein the receiving comprises receiving the original image from the storage device.

12. The method of claim 10, further comprising providing the stereoscopic image to the storage device.

13. The method of claim 8, wherein the altering comprises receiving edge alteration information from a user via a user interface and employing the edge alteration information in forming the side region altered depth map.

14. An apparatus configured to create a stereoscopic image, comprising:
a processor configured to receive an original image, the processor configured to:
create a depth map of the original image, the depth map comprising a left side depth map side region adjacent to a left edge of a periphery of the depth map and a right side depth map side region adjacent to a right edge of the periphery of the depth map, wherein the depth map has brightest pixels assigned to original image features having largest values of negative parallax transitioning to darkest pixels to image features having largest values of positive parallax; and
alter the left side depth map side region and the right side depth map side region of the depth map gradually toward zero parallax at the left edge and the right edge, respectively, of the depth map while maintaining parallax and brightness values of the depth map outside the left side depth map side region and the right side depth map side region, thereby forming a side region altered depth map
wherein the side region altered depth map and original image are combined to form the stereoscopic image.

15. The apparatus of claim 14, further comprising a storage element configured to maintain data.

16. The apparatus of claim 15, wherein the processor receives the original image from the storage element.

17. The apparatus of claim 15, wherein the stereoscopic image is stored in the storage element.

18. The apparatus of claim 15, wherein the means for altering comprise means for receiving edge alteration information from a user via a user interface and employing the edge alteration information in forming the side region altered depth map.
